(19) United States
(12) Patent Application Publication
(10) Pub. No.: US 2010/0033452 A1
(43) Pub. Date: Feb. 11, 2010

(54) Remote Controller for Light Emitting Diode Module

(76) Inventors: Tsung-Lin YU, Hsin-Chu Hsein (TW); Hua-Lung Tzou, Hsin-Chu Hsein (TW); Meng-Chai Wu, Hsin-Chu Hsein (TW)

Correspondence Address: TROXELL LAW OFFICE, PLLC, P.O. Box 1370, Annandale, VA, 22003, US

(21) Appl. No.: 12/329,599

(22) Filed: Dec. 7, 2008

(30) Foreign Application Priority Data
Aug. 8, 2008 (TW) 97130166

(51) Int. Cl. G09G 5/00

(52) U.S. Cl. 345/204

(57) ABSTRACT

A remote controller according to the present invention comprises a power transfer module, a first display module, a control module and a driving circuit. The first display module is provided with some light emitting dices corresponding to the polycrystalline light emitting diodes of the light emitting diode module. Each light emitting dice of the first display module is mainly controlled by the control module to present a mixed color of light and the light emitting diode module is synchronously actuated by the driving circuit to enable the mixed color of light of the light emitting diode module and the first display module to be presented synchronously, thus increasing the operative convenience and improving the control accuracy.

### BACKGROUND OF THE INVENTION

(a) Field of the Invention

The present invention relates to a control device for a light emitting diode module, and aims to provide a remote controller for a light emitting diode module with more operative convenience and effectively improved control accuracy.

(b) Description of the Prior Art

Different from traditional fluorescent tubes or incandescent bulbs, light emitting diodes (LEDs) are performed in a solid-state mode and their lifetimes can be effectively lengthened because of no damage from gas or vacuum tubes and with better resistances to shock, swing motion and abrasion. With markedly increased product value of light emitting diodes, high-intensity light emitting diodes are developed incessantly. As far as the market of light sources is concerned, high-intensity light emitting diodes are rapidly occupying the market of traditional fluorescent tubes or incandescent bulbs in the applications of electric torches, searchlights, camp lights, flashing lights, medical instruments lights, even outdoor lighting, advertising displays and night lighting systems, and the like.

As illustrated in FIG. 1, there is a light emitting diode module popularly used in outdoor facilities. This light emitting diode module 10 is mainly constructed with some polycrystalline light emitting diodes 11 and a controller 20, which is relatively disposed at the far end, for controlling the mixing ratio of a mixed light of each light emitting dice 111 (such as red, green and blue light emitting dices) inside the polycrystalline light emitting diodes 11, thus achieving a specific color representation.

The above-disclosed light emitting diode module is polycrystalline type, so it has better working efficiency and better color rendering properties. However, based on the differences in driving voltages and light output rates among different light emitting dices 111, although the conventional controller 20 is cooperatively provided with some light emitting diodes 21 (for example, red, green and blue light emitting diodes) respectively corresponding to the light emitting dices 111 of the light emitting module 10 to represent the mixed-color arrangement for the far-end light emitting module 10, this only provides the operator to view the brightness of each light emitting diode 21 from the controller 20, not to view the actual color representation of each light emitting dices 111 after light mixing via the controller 20.

Particularly, there are many spatial barriers and restrictions between the light emitting diode module 10 arranged outdoors and the controller 20, it is unsuitable for the operator to perform back and forth review and adjustment, leading the whole operation process to be more complicated and its control effect to be much poorer than expected.

### SUMMARY OF THE INVENTION

In view of the above-mentioned circumstances, a primary objective of the present invention aims to provide a remote controller for a light emitting diode module with more operative convenience and effectively improved control accuracy.

To achieve the above objective, a remote controller according to the present invention comprises a power transfer module, a first display module, a control module and a driving circuit; wherein the first display module is provided with some light emitting dices corresponding to the polycrystalline light emitting diodes of the light emitting diode module; the entire remote controller is connected with an external power source principally by the power transfer module to provide the power source necessary for the operation of the entire remote controller and the light emitting diode module, a control module controls each light emitting dice of the first display module with an output pulse to present a mixed color of light and synchronously amplifies the pulse outputted by the control module through the driving circuit to actuate the light emitting diode module so as to enable the mixed color of light of the polycrystalline light emitting diodes of the light emitting diode module and the first display module of the remote controller to be presented synchronously, thus increasing the operative convenience and improving the control accuracy.

The first effect of the present invention is that the mixed color of light presented by each light emitting dice of the first display module is the synchronous mixed color of light presented by the light emitting diode module such that the operator can directly view the actual color representation of the light emitting diode module from the first display module of the remote controller, thereby relatively increasing the operative convenience.

The second effect of the present invention is that the mixed color of light presented by each light emitting dice of the first display module is the synchronous mixed color of light presented by the light emitting diode module, thereby relatively improving the control accuracy

### BRIEF DESCRIPTION OF THE DRAWINGS

FIG. 1 is a schematic view showing a structure of a conventional controller for a light emitting diode module.

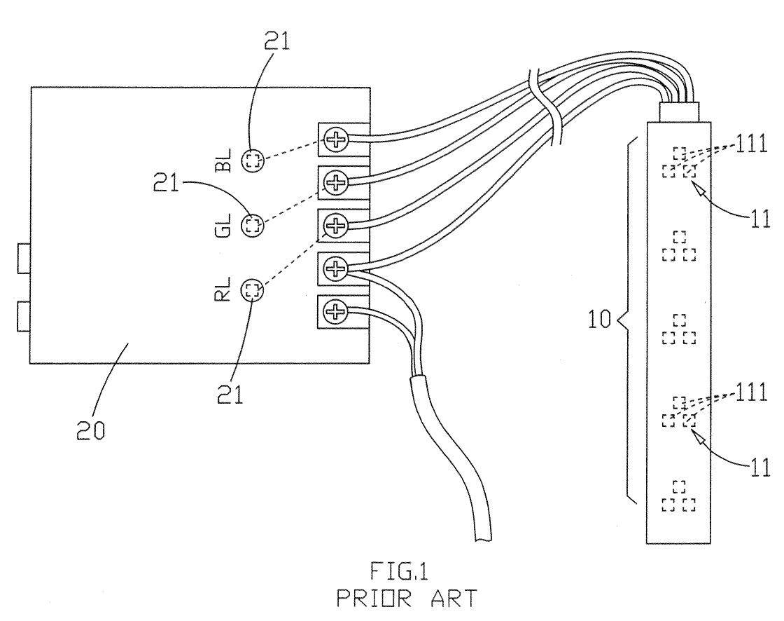

FIG. 2 is a schematic block diagram showing the composition of a remote controller according to the present invention.

FIG. 3 is a schematic view showing a structure of a remote controller according to the present invention.

FIG. 4 is a schematic view showing pulses of each light emitting dice according to the present invention.

FIG. 5 is a schematic view showing an action of a remote controller according to the present invention.

FIG. 6 is a schematic view showing another action of a remote controller according to the present invention.

FIG. 7 is a sectional view showing a structure of a first display module according to a first embodiment of the present invention.

FIG. 8 is a sectional view showing a structure of a first display module according to a second embodiment of the present invention.

FIG. 9 is a sectional view showing a structure of a first display module according to a third embodiment of the present invention.

FIG. 10 is a schematic view showing a structure of a remote controller according to a fourth embodiment of the present invention.

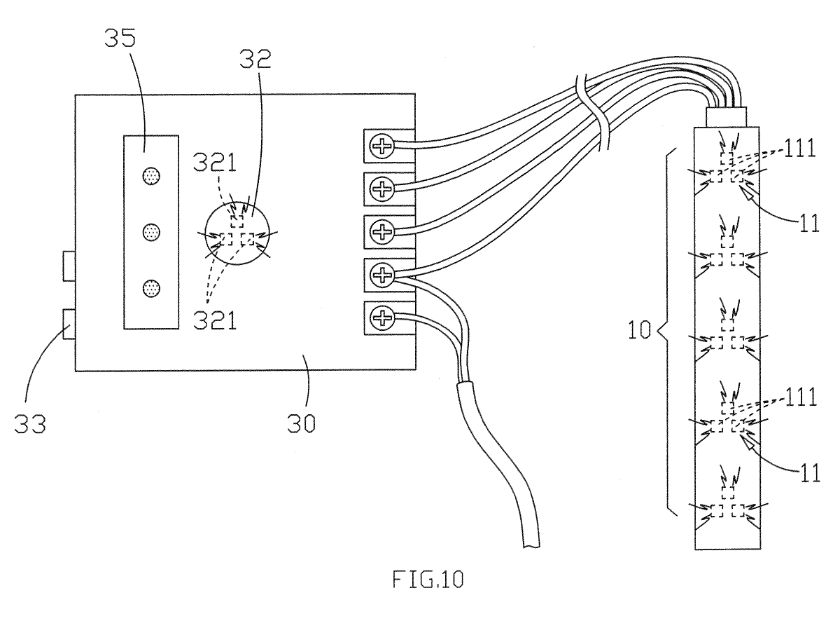

### DETAILED DESCRIPTION OF THE PREFERRED EMBODIMENTS

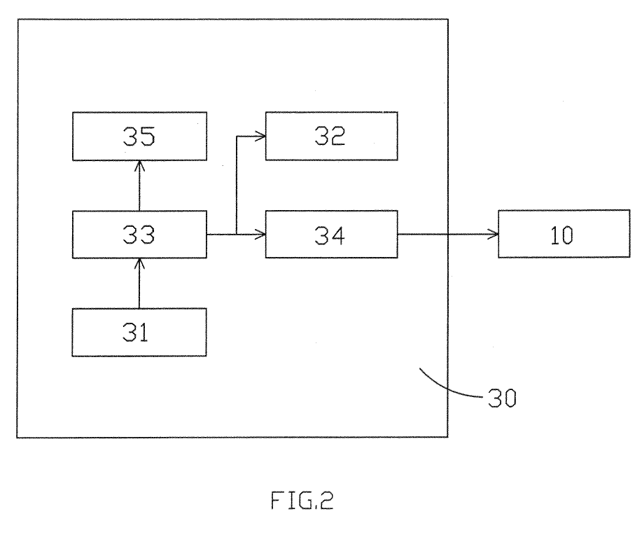

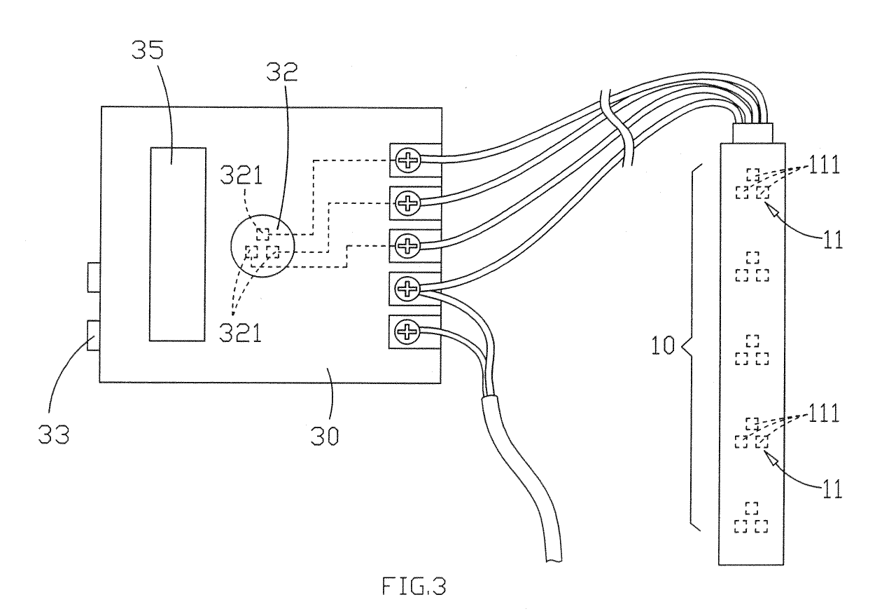

As illustrated in FIGS. 2 and 3, a remote controller 30 for a light emitting diode module 10 according to the present invention mainly comprises: a power transfer module 31, a first display module 32, a control module 33 and a driving circuit 34; wherein

The power transfer module 31 is connected with an external power source to provide the power source necessary for the operation of the entire remote controller 30 and the light emitting diode module 10 connected to the remote controller 30.

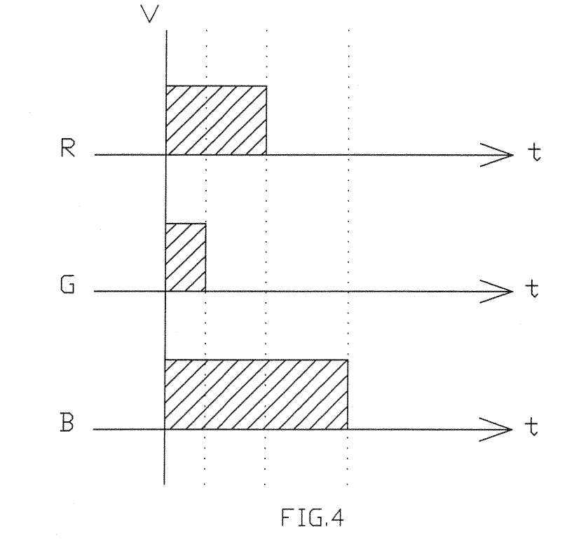

The first display module 32 is provided with some light emitting dices 321 corresponding to each light emitting dice 111 of the polycrystalline light emitting diodes 11 of the light emitting diode module 10; the above control module 33 controls each light emitting dice 321 of the first display module 32 with an output pulse (as illustrated in FIG. 4) to present a mixed color of light.

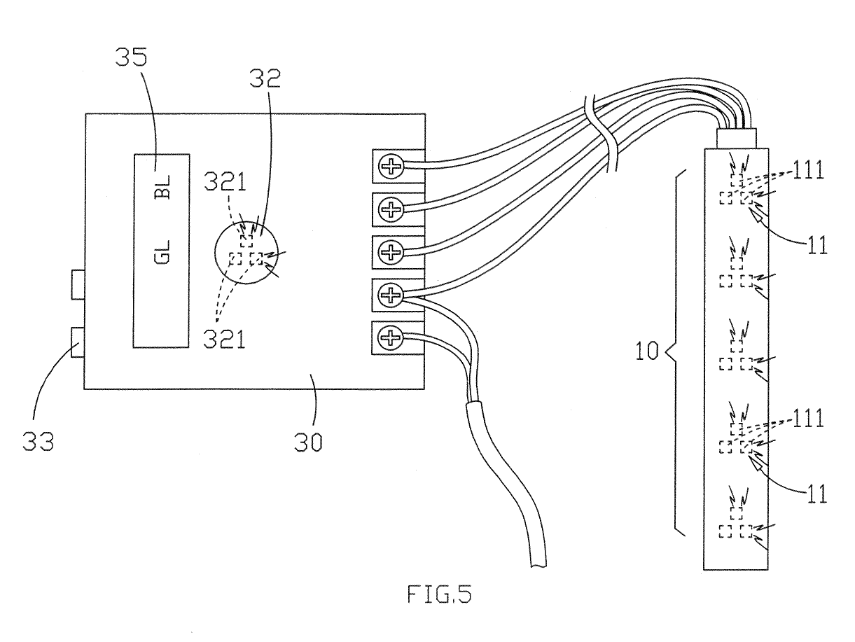

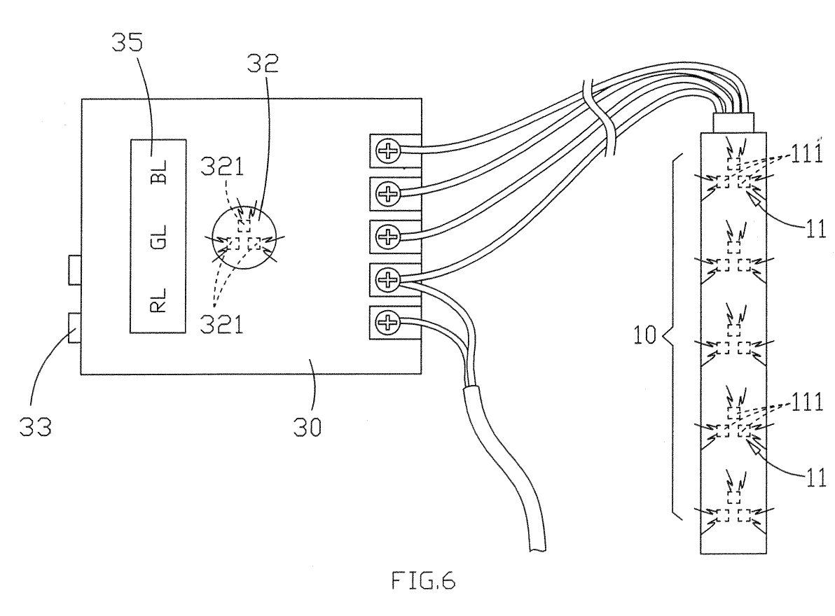

With regard to the driving circuit 34, it is electrically connected with the light emitting diode module 10 connected to the remote controller 30 and synchronously amplifies the pulse outputted by the control module 33 to actuate the light emitting diode module 10, as illustrated in FIGS. 5 and 6, so as to enable the mixed color of light of the polycrystalline light emitting diodes 11 of the light emitting diode module 10 and the first display module 32 to be presented synchronously.

Since the mixed color of light presented by each light emitting dice 321 of the first display module 32 is the synchronous mixed color of light presented by each light emitting dice 111 of the polycrystalline light emitting diodes 11 of the light emitting diode module 10, the operator can directly view the actual color representation of the light emitting diode module 10 from the first display module 32 of the remote controller 30. In other words, the operator can obtain the corresponding actual color representation of the light emitting diode module 10 from the colors presented by the first display module 32 without back and forth review and adjustment, thereby relatively increasing the operative convenience and improving the control accuracy.

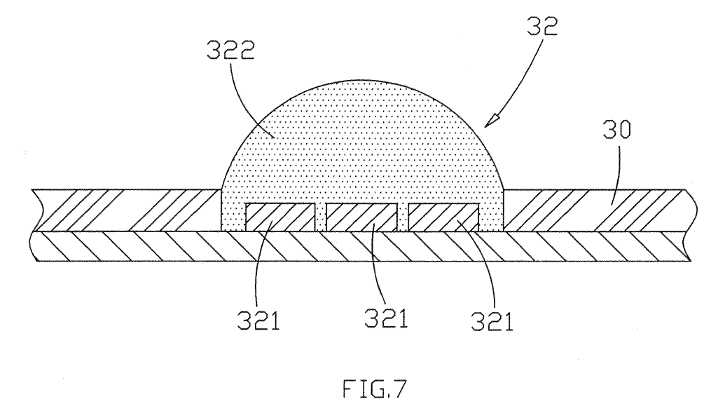

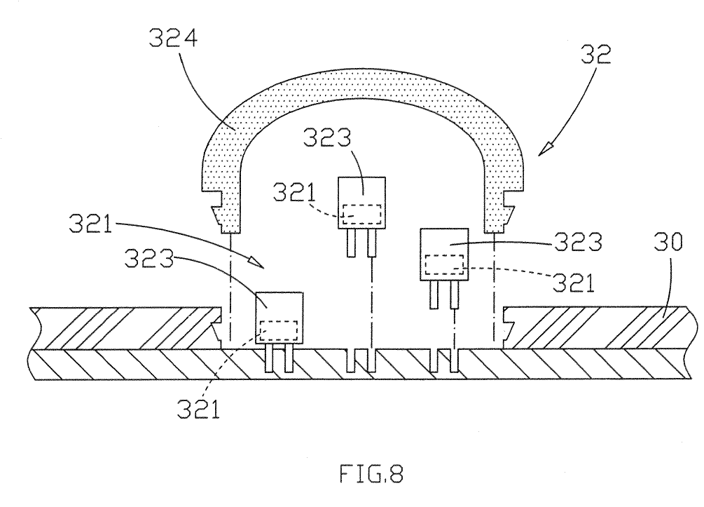

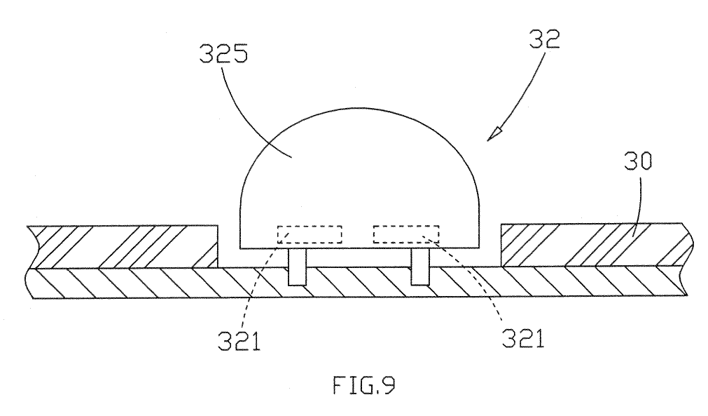

In the implementation of the present invention, the above first display module 32 can be, as illustrated in FIG. 7, directly sealed on the outer layer of all of the single dies to form a light transmissive layer 322; or as illustrated in FIG. 8, each light emitting dice 321 is comprised of a light emitting diode 323 of a single specific color, and the outer layer of all the light emitting diodes 323 of a single color is further covered with a seal casing 324 to present a mixed color effect of all the light emitting diodes of a single color (all the light emitting dices of a single color); of course, the first display module 32 can also be, as illustrated in FIG. 9, a light emitting diode 325 for emitting mixed light integrally comprised of multiple light emitting dices 321, and is further disposed on the remote controller 30 by insertion or bonding.

Furthermore, as illustrated in FIGS. 2 and 5, the control module 33 of the entire remote controller 30 is further coupled with a liquid crystal display module 35 which displays the operation status of the control module 33 with symbols, as illustrated in FIG. 5, or displays the operation status of the control module 33 with colors, or even can assist in increasing the operative convenience and avoid the influence of the color control effect on the light emitting diode module 10 due to human judgment errors through display modes with waveforms or numerical values.

Moreover, the first display module 32 is provided therein with two or more than two light emitting dices 321 of different colors, such as dices for emitting monochromatic light of three colors, red (R), green (G) and blue (B), thereby modulating white light of a specific color temperature or light of other colors; or only provided with dices for emitting monochromatic light of two colors, blue and yellow, thereby modulating white light of a specific color temperature; or can be only provided with dices for emitting monochromatic light of two colors, blue and red, thereby modulating purple light.

As mentioned above, the prevent invention provides an improved remote controller for a light emitting diode module, and the application for a patent is duly filed accordingly. The technical contents and features of the present invention are disclosed above. However, anyone familiar with the technique could possibly make modify or change the details in accordance with the present invention without departing from the spirit of the invention. The protection scope of the present invention shall not be limited to what embodiment discloses, and should include various modification and changes that are made without departing from the spirit of the present invention, and should be covered by the claims mentioned below.

I claim,

1. A remote controller for a light emitting diode module comprising:
a power transfer module, which is connected with an external power source to provide the power source necessary for the operation of the entire remote controller and the light emitting diode module connected to the remote controller;
a first display module, which is provided with some light emitting dices corresponding to the polycrystalline light emitting diodes of the light emitting diode module;
a control module, which controls each light emitting dice of the first display module with an output pulse to present a mixed color of light; and
a driving circuit, which is electrically connected with the light emitting diode module connected to the remote controller and synchronously amplifies the pulse outputted by the control module to actuate the light emitting diode module.

2. The remote controller for a light emitting diode module as claimed in claim 1, wherein the first display module is directly sealed on the outer layer of all of the single dies to form a light transmissive layer.

3. The remote controller for a light emitting diode module as claimed in claim 1, wherein each light emitting dice of the first display module is comprised of a light emitting diode of a single specific color, and all the light emitting diodes of a single color are further covered with a seal casing.

4. The remote controller for a light emitting diode module as claimed in claim 1, wherein the first display module is a light emitting diode for emitting mixed light integrally comprised of multiple light emitting dices, and is further disposed on the remote controller by insertion or bonding.

5. The remote controller for a light emitting diode module as claimed in claim 1, wherein the control module is coupled with a liquid crystal display module for displaying the operation status of the control module.

6. The remote controller for a light emitting diode module as claimed in claim 5, wherein the liquid crystal display module displays the operation status of the control module with symbols.

7. The remote controller for a light emitting diode module as claimed in claim 5, wherein the liquid crystal display module displays the operation status of the control module with colors.

8 The remote controller for a light emitting diode module as claimed in claim 5, wherein the liquid crystal display module displays the operation status of the control module with waveforms.

9. The remote controller for a light emitting diode module as claimed in claim 5, wherein the liquid crystal display module displays the operation status of the control module with numerical values.

10. The remote controller for a light emitting diode module as claimed in claim 1, wherein the first display module is provided therein with two or more than two light emitting dices of different colors.

11. The remote controller for a light emitting diode module as claimed in claim 10, wherein the first display module is provided there in with dices for emitting monochromatic light of three colors, red, green and blue.

12. The remote controller for a light emitting diode module as claimed in claim 10, wherein the first display module is provided therein with dices for emitting monochromatic light of two colors, blue and yellow.

13. The remote controller for a light emitting diode module as claimed in claim 10, wherein the first display module is provided therein with dices for emitting monochromatic light of two colors, blue and red.
